(19) United States
(12) Patent Application Publication
(10) Pub. No.: US 2011/0193806 A1
(43) Pub. Date: Aug. 11, 2011

(54) MOBILE TERMINAL HAVING MULTIPLE DISPLAY UNITS AND DATA HANDLING METHOD FOR THE SAME

(75) Inventors: Hyun Kyoung KIM, Seoul (KR); Sung Guk NAM, Seoul (KR)

(73) Assignee: SAMSUNG ELECTRONICS CO. LTD., Suwon-si (KR)

(21) Appl. No.: 13/015,914

(22) Filed: Jan. 28, 2011

(30) Foreign Application Priority Data
Feb. 10, 2010 (KR) 10-2010-0012434

(51) Int. Cl. G06F 3/041; G09G 5/00

(52) U.S. Cl. 345/173; 345/1.3

(57) ABSTRACT

A mobile terminal having multiple display units is disclosed. The mobile terminal includes, a display means having multiple display units, a storage unit for storing at least one application program that outputs data on at least one of the display units when activated, and a control unit for examining a presentation attribute of an application program selected according to an input signal or preset schedule information, and for controlling at least one of the display units to output data generated by the selected application program after activation according to the presentation attribute.

### PRIORITY

This application claims the benefit under 35 U.S.C. § 119(a) of a Korean patent application filed on Feb. 10, 2010 in the Korean Intellectual Property Office and assigned Serial No. 10-2010-0012434, the entire disclosure of which is hereby incorporated by reference.

### BACKGROUND OF THE INVENTION

1. Field of the Invention

The present invention relates to a mobile terminal. More particularly, the present invention relates to a mobile terminal having multiple display units and a data handling method for the same.

2. Description of the Related Art

Thanks to recent advances in battery technology that have reduced battery size while maintaining the same capacity, mobile terminals are now capable of providing a variety of additional functions. For example, a typical mobile terminal supports optional functions, such as playback of audio and video files containing music or educational materials, or capturing still images or moving images using a still or video camera.

The mobile terminal may support various types of voice and data communication including mobile communication with a base station, short-range communication with a nearby device, and Internet access.

For portability reasons, mobile terminals tend to have a small display area. Although many schemes have been proposed to enlarge the display area, the amount of data displayable on a single display unit is restricted. Hence, to overcome this restriction, it is necessary to develop a mobile terminal and a related method of operating a mobile terminal that enable appropriate presentation of data associated with application programs.

### SUMMARY OF THE INVENTION

An aspect of the present invention is to address at least the above-mentioned problems and/or disadvantages and to provide at least the advantages described below. Accordingly, an aspect of the present invention is to provide a mobile terminal having multiple display units and a data handling method for the same that perform active and dynamic presentation of data in concert with activation of various application programs to enlarge the display area seen by the user.

In accordance with an aspect of the present invention, a data handling method for a mobile terminal having multiple display units is provided. The method includes, selecting a particular application program, examining a presentation attribute of the selected application program, and performing, according to the presentation attribute, output control to output data generated by activation of the selected application program on at least one of the multiple display units.

In accordance with another aspect of the present invention, a mobile terminal having multiple display units is provided. The terminal includes, a display means having multiple display units, a storage unit for storing at least one application program that outputs data on at least one of the display units when activated, and a control unit for examining a presentation attribute of an application program selected according to an input signal or preset schedule information, and for controlling at least one of the display units to output data generated by the selected application program after activation according to the presentation attribute.

According to an aspect of the present invention, a mobile terminal having multiple display units and a data handling method for the same enable various data to be presented on the individual display units according to properties of application programs. Hence, the user may use application programs of the mobile terminal in a more interactive and dynamic manner.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiment of the present invention will be more apparent from the following description taken in conjunction with the accompanying drawings, in which:

FIGS. 1A and 1B illustrate an external appearance of a mobile terminal according to an exemplary embodiment of the present invention;

FIG. 2 is a block diagram of a mobile terminal according to an exemplary embodiment of the present invention;

FIG. 3 illustrates a configuration of a control unit in a mobile terminal according to an exemplary embodiment of the present invention;

FIG. 4 is a flowchart of a data handling method for a mobile terminal according to an exemplary embodiment of the present invention;

FIG. 5 illustrates output of application data in relation to a link-view presentation attribute according to an exemplary embodiment of the present invention;

FIG. 6 illustrates output of application data in relation to a total-view presentation attribute according to an exemplary embodiment of the present invention;

FIG. 7 illustrates output of application data in relation to an execution-view presentation attribute according to an exemplary embodiment of the present invention;

FIG. 8 illustrates a user interface feature for setting a presentation attribute according to an exemplary embodiment of the present invention;

FIG. 9 illustrates changes in application data presentation according to an exemplary embodiment of the present invention; and

FIG. 10 illustrates changes in application data presentation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

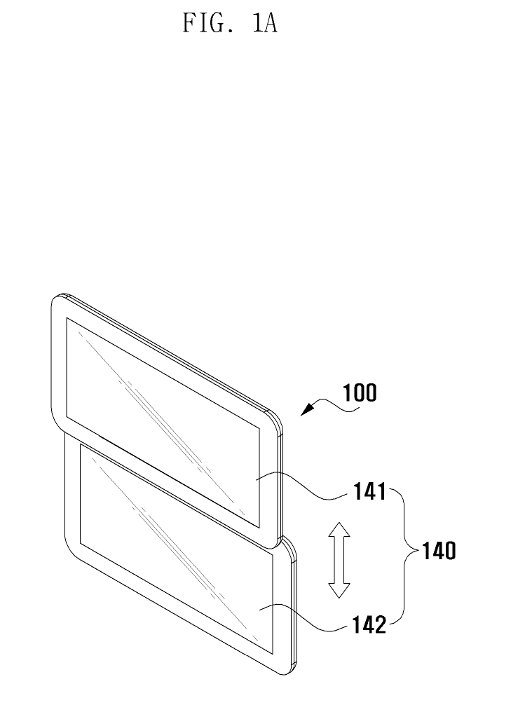

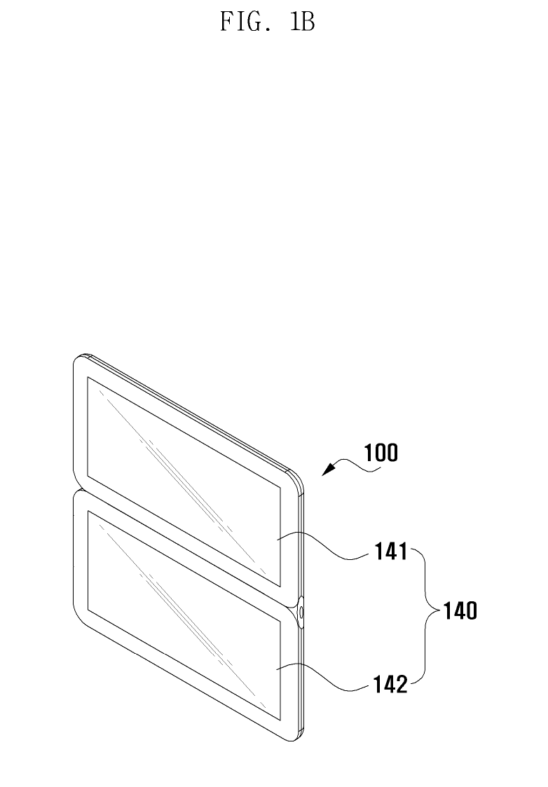

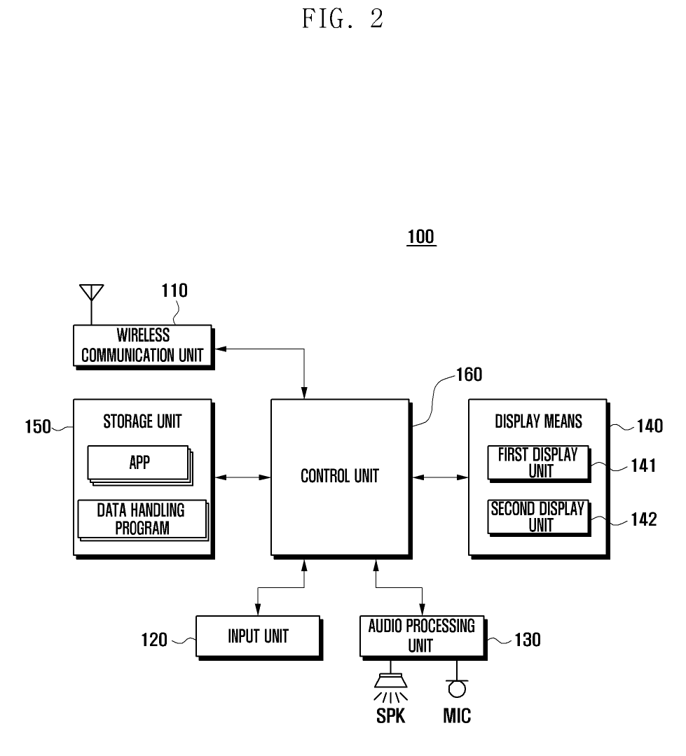

FIGS. 1A and 1B illustrate an external appearance of a mobile terminal according to an exemplary embodiment of the present invention, and FIG. 2 is a block diagram of a mobile terminal according to an exemplary embodiment of the present invention.

Referring to FIGS. 1A, 1B and 2, the mobile terminal 100 includes a wireless communication unit 110, an input unit 120, an audio processing unit 130, a display means 140 having multiple displays, a storage unit 150, and a control unit 160. It should be apparent to one of skill in the art that this configuration includes only components necessary for describing data arrangement and display according to exemplary embodiments of the present invention and that the present invention is not limited thereto or thereby. For example, the mobile terminal 100 may further include various components such as a camera module, a short-range communication module, a broadcast reception module, and the like. As another example, to monitor motion states, the mobile terminal 100 may further include at least one of various sensors such as a geomagnetic sensor and an acceleration sensor.

The mobile terminal 100 having the above configuration may change the arrangement of data items and display formats thereof on the display means 140 according to presentation attributes of application programs stored in the storage unit 150. That is, when an application program is selected according to an input signal from the user or by preset schedule information, the mobile terminal 100 may identify the presentation attribute of the application program, and determine which display unit of the display means 140 is to be used to output data items generated by the application program on the basis of the identified presentation attribute. The mobile terminal 100 may also determine the display format of the output data items in terms of size, range, orientation and the like on the basis of the presentation attribute. In addition, the mobile terminal 100 may determine the orientation, size and range of data items displayed on the display means 140 according to a sensing signal received from a sensor, and adjust the arrangement of the data items accordingly. For example, when the display means 140 is oriented horizontally, the mobile terminal 100 may determine to output data in a landscape orientation. When the display means 140 is oriented vertically, the mobile terminal 100 may determine to output data in a portrait orientation.

The wireless communication unit 110 sends and receives signals for wireless communication for the mobile terminal 100. The wireless communication unit 110 may include a radio frequency transmitter for upconverting the frequency of a signal to be transmitted and amplifying the signal, and a radio frequency receiver for low-noise amplifying a received signal and downconverting the frequency of the received signal. The wireless communication unit 110 may forward a signal received through a radio channel to the control unit 160, and may transmit a signal from the control unit 160 through the radio channel. Furthermore, the wireless communication unit 110 may transfer data received from another mobile terminal to a specified display unit under control of the control unit 160. The display unit to be used to output data received through the wireless communication unit 110 may be changed according to preset schedule information or user selection. When the wireless communication unit 110 is activated by the control unit 160, the display means 140 may be set to output various data necessary for operation of the wireless communication unit 110. Hence, when the wireless communication unit 110 is activated, data related to the wireless communication unit 110 may be output to at least one of the display units of the display means 140. For example, when the wireless communication unit 110 is activated to place a call, call related data such as a telephone number and phonebook entry (and an image in the case of a video call) may be displayed on the first display unit 141, and call control images or data may be displayed on the second display unit 142. The wireless communication unit 110 may establish a data communication channel with a Web server in response to a user request and receive data items of a specific webpage, in which case the received data items may be output to at least one display unit of the display means 140 under control of the control unit 160.

The input unit 120 receives input signals for manipulating the mobile terminal 100 from the user and forwards the input signals to the control unit 160. To provide this input function, the input unit 120 includes a plurality of alphanumeric and function keys for inputting alphanumeric information and for setting various functions. More particularly, the input unit 120 provides buttons to generate input signals for rearranging data items displayed on the display means 140, for changing display formats, for transferring data between display units, and for selecting an application program. The input unit 120 generates an input signal corresponding to such a user request and forwards the input signal to the control unit 160.

The audio processing unit 130 may include a coder/decoder (codec), a speaker (SPK) for reproducing an audio signal decoded by the codec, and a microphone (MIC) for collecting an external audio signal. The codec may include a data codec for processing packet data and the like, and an audio codec for processing an audio signal such as a voice signal. In voice call processing, the audio processing unit 130 converts a digital audio signal from the control unit 160 into an analog signal through the audio codec to reproduce the analog signal through the speaker, and converts an analog audio signal from the microphone into a digital audio signal through the audio codec to provide the digital audio signal to the control unit 160. More particularly, the audio processing unit 130 may establish different audio paths related to the individual display units under control of the control unit 160. For example, when data is displayed on the first display unit 141 and the second display unit 142 according to settings by the user or an application program, the audio processing unit 130 may establish an audio path to reproduce an audio signal contained in the data on the first display unit 141 or the second display unit 142. In addition, although the audio processing unit 130 is set to reproduce an audio signal contained in data to be output to a first display unit, when no audio signal is contained in the data to be output to the first display unit, the audio processing unit 130 may notify the control unit 160 and determine whether an audio signal is contained in data to be output to a second display unit. When an audio signal is contained in the data to be output to the second display unit, the audio processing unit 130 may reconfigure audio path settings to reproduce the audio signal contained in the data to be output to the second display unit. In the case where both data to be output to a first display unit and data to be output to a second display unit contain an audio signal, the audio processing unit 130 may reproduce an audio signal related to one of the first display unit and the second display unit according to preset settings. Further, when data to be output to a display unit is changed by the user, the audio processing unit 130 may determine whether an audio signal is contained in new data and, only when an audio signal is contained in the new data, adjust audio path settings to reproduce the audio signal in the new data. In other words, the audio processing unit 130 may adaptively reconfigure audio paths for audio output according to the presence of an audio signal related to individual display units, a change of data to be output, and preset settings.

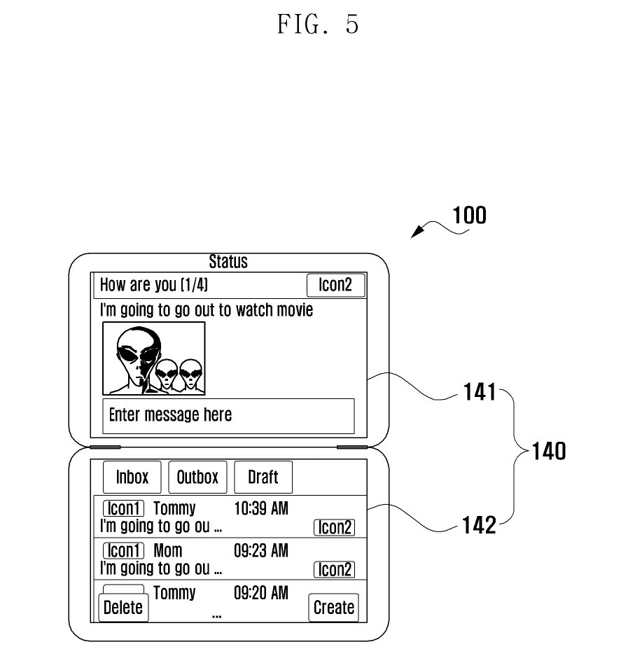

As shown in FIGS. 1A and 1B, the display means 140 may include multiple display units that can display data together when opened (slide open or folder open). In the present description, the multiple display units are referred to as a first display unit 141 and a second display unit 142. However, the display means 140 may include more than two display units, and the subject matter of the present invention relates to operation of the display units to output data of an active application program in a user-convenient manner. Each of the first display unit 141 and second display unit 142 may be realized using a flat display panel composed of Liquid Crystal Display (LCD) devices or Organic Light Emitting Diodes (OLEDs), and may include a display controller and a memory for storing video data. A touch panel may be placed on the flat display panel to provide a touch screen capability to the display means 140. In this case, the display means 140 may act as an input means. More particularly, the first display unit 141 and the second display unit 142 may display data separately or together according to properties of activated application programs. For example, the first display unit 141 and the second display unit 142 may display data generated by a single application program together according to a preset condition, or may independently display data generated by two or more application programs according to another preset condition. When functions of application programs are grouped into different categories, the first display unit 141 and the second display unit 142 may separately display data belonging to the different categories upon activation of an application program. Output of application program data is described further in connection with FIGS. 5 to 7.

The storage unit 150 includes a program area and a data area. The program area stores programs such as an operating system to control the overall operation of the mobile terminal 100, programs (APP) to initialize the components such as the wireless communication unit 110 and display means 140, and programs (APP) to operate other components such as a camera module and broadcast reception module. More particularly, the program area may store a data handling program.

The data handling program controls, in response to activation of an application program, presentation of data generated by the application program on the display means 140 in a specific format according to the presentation attribute assigned to the application program. The data handling program is loaded in the control unit 160 when the mobile terminal 100 is turned on, and controls an activated application program to output generated data to a specific display unit. More specifically, the data handling program includes a routine for determining the presentation attribute of an application program selected by an input signal or preset schedule information, a routine for arranging application data to be output to the display means 140 according to the presentation attribute, a routine for controlling output of the arranged application data to a specific display unit, a routine for determining the presentation attribute of a new application program selected by an input signal, a routine for rearranging application data to be output by comparing the presentation attribute of the current application program with that of the newly selected application program in terms of preset conditions and a routine for controlling output of the rearranged application data to a specific display unit. The data handling program may further include a routine for controlling output of an audio signal according to the presentation attribute of an application program, a routine providing an environment for setting a presentation attribute of an application program, and a routine for defining a presentation attribute of the application program according to an input signal.

The data area may store data generated by a running application program such as phonebook data, content data, or recorded sound or image data. More particularly, the data area may store information regarding presentation attributes. The information regarding presentation attributes of individual application programs may be adjusted after the data handling program is activated.

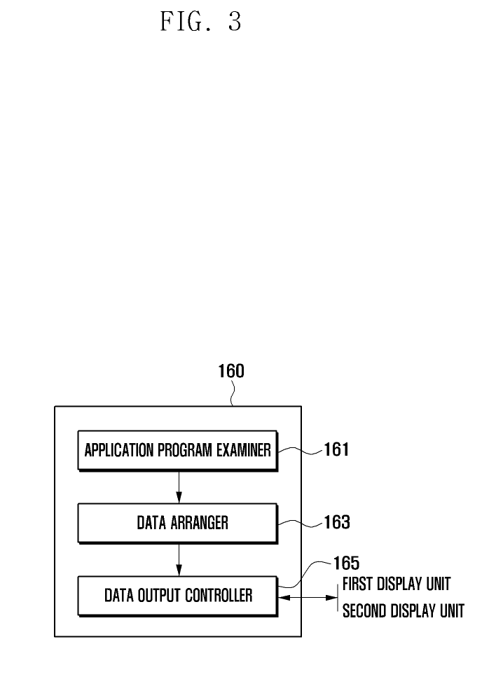

The control unit 160 controls the overall operation of the mobile terminal 100. More particularly, the control unit 160 controls an operation to arrange data to be output to the display units of the display means 140 and display the arranged data on the display means 140. The control unit 160 may be configured as shown in FIG. 3 to determine locations, directions, sizes and ranges of application data items to be output to the display means 140 according to the presentation attribute of an application program.

FIG. 3 illustrates a configuration of a control unit in a mobile terminal according to an exemplary embodiment of the present invention.

Referring to FIG. 3, the control unit 160 may include an application program examiner 161, a data arranger 163, and a data output controller 165.

The application program examiner 161 identifies a presentation attribute of an application program specified by preset schedule information or an input signal. The presentation attribute specifies at least one of a display location, arrangement direction, size and range of application data generated by an activated application program. The display location indicates one or more of the multiple display units of the display means 140 to be used for displaying application data. Here, application data may be generated by a single application program or multiple application programs. The application program examiner 161 may provide a user interface feature to adjust a presentation attribute of a specified application program. The user interface feature for adjusting a presentation attribute is described later with reference to the accompanying drawings.

The data arranger 163 arranges application data generated by an activated application program according to the presentation attribute of the application program identified by the application program examiner 161. More specifically, the data arranger 163 may subdivide the memory space allocated to the display means 140 into memory segments specific to the individual display units, and arrange data items generated by at least one application program in the memory segment specific to one display unit. For example, when the display means 140 includes first and second display units 141 and 142, the data arranger 163 subdivides the memory space allocated to the display means 140 into memory segments specific to the first and second display units 141 and 142. Then, the data arranger 163 may control an operation to write data items generated by an activated application program in at least one of the memory segments specific to the first and second display units 141 and 142 according to the presentation attribute of the application program. In addition, when a second application program is activated while a first application program is active, the data arranger 163 may control an operation to identify the presentation attribute of the second application program, compare the presentation attribute of the second application program with that of the first application program, and arrange data items generated by the application programs in a memory segment according to the comparison result. To achieve this, the presentation attribute of an application program may have priority information for a memory segment. The data arranger 163 may determine whether to arrange data items of a particular application program in the memory space allocated to the display means 140, and adjust memory segments to be used for arranging data items generated by multiple active application programs, on the basis of priority information of the application programs. For example, a first application program is assumed to have a presentation attribute specifying that generated data is to be output to all the display units of the display means 140 when it is the only active application, and that generated data is to be output to one of the display units of the display means 140 when a second application program is activated while the first application program is still active. When the first application program is activated, the data arranger 163 may arrange data generated by the first application program in the memory space allocated for the display means 140 to output the generated data to all display units of the display means 140. Later, when a second application program is selected, the data arranger 163 may subdivide the memory space allocated to the display means 140 into memory segments corresponding respectively to the display units, rearrange the data generated by the first application program in one of the memory segments, and arrange data generated by the second application program in the other memory segment. In this process, the data arranger 163 may reduce the amount of display data by reducing, or discarding some of, the screen image size of the data having been displayed on all of the display units according to design or user settings.

The data output controller 165 controls output of data arranged in the memory space allocated to the display means 140 to the corresponding display unit. To achieve this, the data output controller 165 may support path exchange between memory segments. For example, it may be assumed that memory segments are respectively assigned to the first display unit 141 and second display unit 142 and a first application program has a presentation attribute specifying data output to the first display unit 141 and a second application program has a presentation attribute specifying data output to the second display unit 142. It may be further assumed that the first application program and second application program are executable at the same time through a paired menu. When the first application program and second application program are activated according to user input, the first application program generates first data items and the second application program may generate second data items. The data arranger 163 arranges the first data items in the memory segment of the first display unit 141 and arranges the second data items in the memory segment of the second display unit 142. The data output controller 165 controls an operation to output the first data items arranged in the memory segment of the first display unit 141 to the first display unit 141 and output the second data items arranged in the memory segment of the second display unit 142 to the second display unit 142. When an input signal is generated requiring movement of data on the first display unit 141 to the second display unit 142 and movement of data on the second display unit 142 to the first display unit 141, the data output controller 165 adjusts paths between the memory segments so that data in the memory segment of the first display unit 141 is output to the second display unit 142 and data in the memory segment of the second display unit 142 is output to the first display unit 141 without requiring data movement between memory segments. Hence, the data output controller 165 may support exchange of display data between display units without explicit data movement between memory segments.

As described above, the mobile terminal 100 enables application data to be output to multiple display units in a manner that is convenient to the user according to the presentation attribute of an application program. Hence, the user utilizing various functions of the mobile terminal may view, arrange, use and store information in a more efficient and convenient manner through the multiple display units.

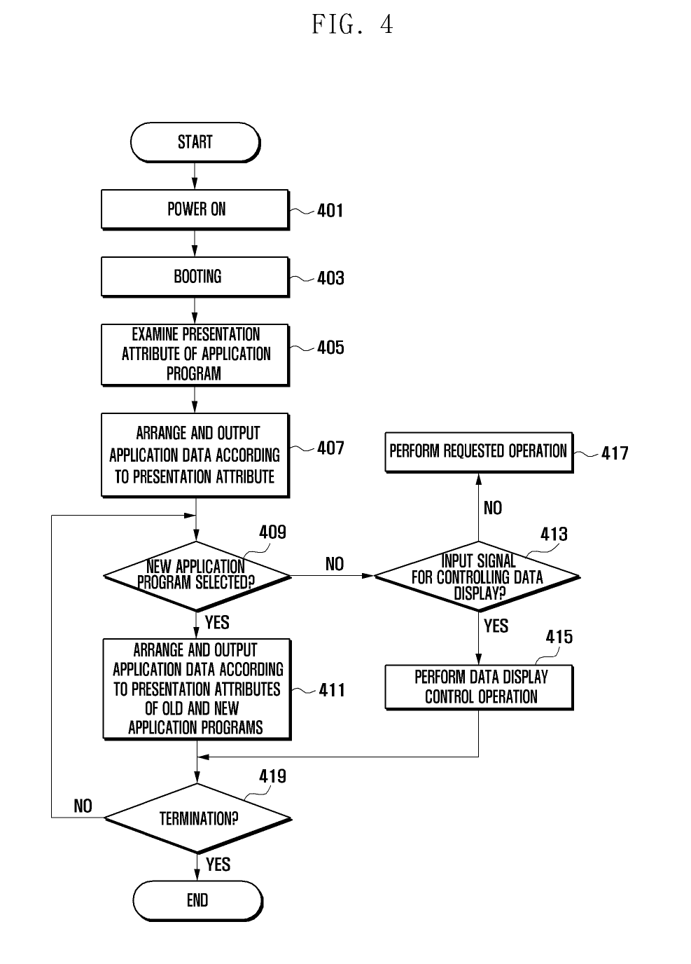

FIG. 4 is a flowchart of a data handling method for a mobile terminal according to an exemplary embodiment of the present invention.

Referring to FIG. 4, the data handling method begins with supplying power to the mobile terminal 100 in step 401. The mobile terminal 100 may have an installed battery or an adaptor connector for a power source. When the user enters, for example, a “power” key, battery power or external power is supplied to the mobile terminal 100, turning on the mobile terminal 100.

After being turned on, the control unit 160 of the mobile terminal 100 performs a boot procedure in step 403. In this step, the mobile terminal 100 loads an operating system from the storage unit 150, and performs an initialization procedure to initialize the components of the mobile terminal 100 such as the wireless communication unit 110, the display means 140 having a touch screen capability, and a sensor monitoring operation states of the mobile terminal 100. After booting, the control unit 160 determines an application program to be activated on the basis of preset schedule information. For example, the control unit 160 may activate application programs related to an idle screen and menus with reference to the schedule information. The control unit 160 examines the presentation attribute of the activated application program in step 405. For example, the control unit 160 may identify the presentation attributes of the application programs related to the idle screen and menus.

The control unit 160 controls arrangement and output of application data according to the identified presentation attribute of the application program in step 407. For example, when the presentation attribute of the application program related to the idle screen indicates data output to the first display unit 141 and the presentation attribute of the application program related to the menus indicates data output to the second display unit 142, the control unit 160 controls an operation to output idle screen data to the first display unit 141 and output menu screen data to the second display unit 142. In this process, the control unit 160 may subdivide the memory space allocated to the display means 140 into memory segments corresponding to the display units, control an operation to arrange data generated by an application program in one memory segment, and control an operation to output idle screen data (arranged data) to the first display unit 141 and output menu screen data (arranged data) to the second display unit 142. During data display, the control unit 160 may control touch panel settings according to attributes of displayed data items. For example, when images on the idle screen are not associated with a touch event, the control unit 160 may control the touch panel on the first display unit 141 not to generate a touch event or to ignore a generated touch event. The control unit 160 may permit the touch panel on the second display unit 142 to generate a touch event for a menu icon on the touch panel.

The control unit 160 determines whether an input signal for selecting a new application program is generated in step 409. The user may generate an input signal for selecting a desired application program using the input unit 120 or the display means 140 having a touch screen capability. If it is determined in step 409 that an input signal for selecting a new application program is generated, the control unit 160 controls application data arrangement and output according to presentation attributes of the old and new application programs in step 411. More specifically, the control unit 160 identifies the priority information of the presentation attribute of the old application program, and identifies the priority information of the presentation attribute of the new application program. Based on the comparison result of the priority information, the control unit 160 may control an operation to output application data of the new application program to all the display units of the display means 140 or to output application data of the new application program to a specified one of the display units of the display means 140 after clearing images already displayed on the specified display unit. To achieve this, the control unit 160 may write new application data of the new application program in the memory space allocated to the display means 140, shift the location of existing application data in the memory space, or remove some of the existing application data in a memory segment specific to one display unit. Here, the control unit 160 may overwrite the existing application data in a memory segment specific to one display unit with data of the new application program without explicit data removal.

On the other hand, if it is determined in step 409 that the generated input signal is not related to selection of a new application program, the control unit 160 determines whether the input signal is related to controlling data display in step 413. If it is determined in step 413 that the input signal is related to controlling data display, the control unit 160 performs a corresponding data display control operation in step 415. For example, in response to the input signal, the control unit 160 may control an operation to move a selected icon on the idle screen to another location.

On the other hand, if it is determined in step 413 that the input signal is not related to controlling data display, the control unit 160 may perform an operation requested by the input signal in step 417. For example, when the input signal is related to a “hold” function, the control unit 160 may shut off power to the touch panel or ignore touch events generated by the touch panel. When the input signal is related to a “menu page”, the control unit 160 may control an operation to remove the current menu page from a given display unit and display the next menu page.

After data manipulation at step 411 or step 415, the control unit 160 determines whether an input signal for termination is generated in step 419. If it is determined in step 419 that an input signal for termination is not generated, the control unit 160 returns to step 409 for continued processing.

As described above, an exemplary data handling method identifies the presentation attribute of an application program selected by schedule information or user input, determines how to output data generated by the application program to the display means 140 on the basis of the presentation attribute, and controls output of the application data according to the determination. Hence, application data can be displayed on a suitable one of the multiple display units in a user convenient manner.

Hereinabove, a description is given of an exemplary configuration of a mobile terminal having multiple display units and the data handling method. Next, data arrangement and output, setting of a presentation attribute for an application program, and data display control will be described with reference to the drawings.

FIG. 5 illustrates output of application data in relation to a link-view presentation attribute according to an exemplary embodiment of the present invention.

Referring to FIG. 5, the first display unit 141 and the second display unit 142 respectively display screens of two linked application programs. The link-view presentation attribute is described using a message listing function and a message view function. However, the present invention is not limited thereto or thereby and various functions or application programs may be linked together through a link-view presentation attribute according to design or user selection. For example, a phonebook listing function may be linked with a phonebook entry view function, a content listing function may be linked with a content view function, a date display function may be linked with a daily schedule view function, a webpage view function may be linked with a linked page view function, and the like. As described above, the user may set a link-view presentation attribute to link a first application program supporting a data output function with a second application program supporting a function for viewing a selected item or entry in displayed data. However, the present invention is not limited thereto, and the user may link other types of application programs together as necessary.

For link-view screen presentation, the user may generate input signals to activate linked application programs in sequence or generate an input signal for selecting a paired menu item associated with linked application programs. For example, the user may generate an input signal by selecting a menu item associated with the message listing function or by entering a shortcut key associated with the message listing function. In response to the input signal, the display means 140 may output a list of messages on at least one display unit. Here, the control unit 160 examines the presentation attribute of the message listing function. The presentation attribute may indicate that the message list is to be output on all of the display units of the display means 140, on the first display unit 141, or on the second display unit 142. After examination of the presentation attribute, the control unit 160 controls an operation to arrange message list data in a portion of the memory space allocated to the display means 140 and to output the message list data to the corresponding display unit. Later, when the user generates an input signal for selecting a particular message of the message list, the control unit 160 analyzes the presentation attributes of the message listing function and the message view function and controls an operation to arrange data to be output to the display means 140 according to the analysis result. For example, when a message is selected while the message list data is displayed on the whole of the display means 140, the control unit 160 may perform a screen adjustment so that the message list data is output on the second display unit 142, and control an operation to output message contents related to the message view function on the first display unit 141. Thereafter, when the user generates an input signal to “close” the message content screen, the control unit 160 may control an operation to recover the previous state (by redisplaying the message list data on the whole of the display means 140). In this process, the control unit 160 may change data arrangement in the memory space allocated to the display means 140.

When the message listing function and the message view function are linked by a paired menu item, the control unit 160 may control the display means 140 to simultaneously output data created by the message listing function and data created by the message view function. In this case, the control unit 160 may control an operation to select by default a particular message (for example, the most recently received message) of a message list and output the contents of the selected message. The control unit 160 may control the first display unit 141 to display the message list data, and control the second display unit 142 to display the message content data related to the message view function. Alternatively, the control unit 160 may control the first display unit 141 to display the message content data related to the message view function, and control the second display unit 142 to display the message list data.

As described above, the mobile terminal 100 may output separate screens of linked application programs on the multiple display units according to the link-view presentation attribute. Hence, the user may conveniently execute application programs having a link-view presentation attribute without the need to enter an input signal to control application data display.

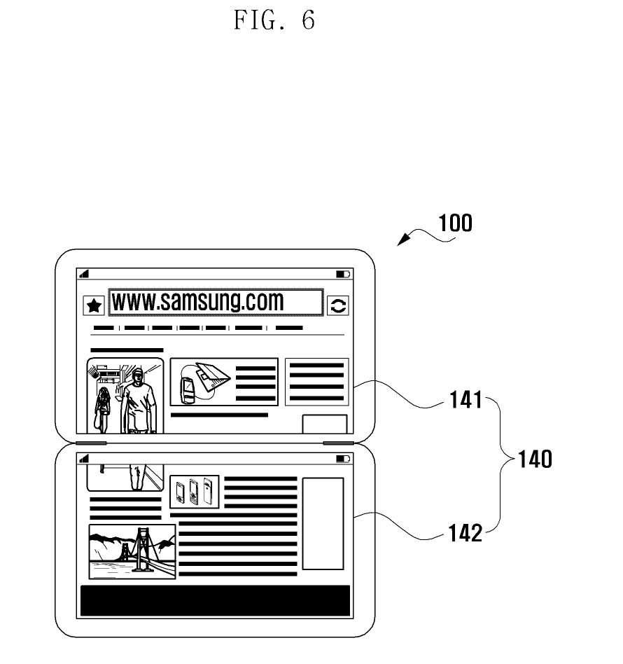

FIG. 6 illustrates output of application data in relation to a total-view presentation attribute according to an exemplary embodiment of the present invention.

Referring to FIG. 6, both the first display unit 141 and the second display unit 142 display application data generated by a single application program. The user may generate an input signal to select and activate an application program having a presentation attribute specifying output of application data to all of the display units of the display means 140. In response to the input signal, the control unit 160 of the mobile terminal 100 examines the presentation attribute of the activated application program and arranges generated application data in the memory space allocated to the display means 140. Here, the control unit 160 may arrange generated data so that the generated data is output to the individual display units. That is, the control unit 160 may subdivide the memory space into multiple memory segments specific to the display units, arrange data items in the memory segments, and control an operation to output the arranged data items to the corresponding display units. For example, the control unit 160 may arrange webpage data items received from a particular web server in two memory segments, and control the first display unit 141 and second display unit 142 to output data items arranged in the corresponding memory segments. Here, the control unit 160 may perform data arrangement and output so that data items on the first display unit 141 are associated with data items on the second display unit 142. That is, the control unit 160 may use the first display unit 141 and the second display unit 142 as a single screen, and perform data arrangement and output to enable the user to view a single webpage through the first display unit 141 and the second display unit 142.

In reality, the data arranger 163 of the control unit 160 may arrange data items of a webpage in the memory space allocated to the display means 140, and the data output controller 165 may output data items arranged in the memory segments of the memory space to the corresponding display units. That is, when a webpage, which is selected according to settings or user input after activation of a web browser, is received from a web server, the data arranger 163 may arrange data items of the webpage in the entire memory space allocated to the display means 140. Then, independently of the data arranger 163, the data output controller 165 may divide the memory space into memory segments corresponding respectively to display units, and control an operation to output data items arranged in the individual memory segments to the corresponding display units. Accordingly, the control unit 160 may output data items to multiple display units using the multiple display units as a single large screen without separate data classification.

Each of the multiple display units may include a touch panel to support touch screen functionality. To use the multiple display units as a single large screen, the control unit 160 may provide settings to the display units so that the multiple touch panels operate as a single entity. To be more specific, a touch panel may have coordinates in units of pixels or several pixels of a corresponding display unit. For example, when a display unit has a size of 100 (x-axis)×100 (y-axis), the touch panel may be defined to have coordinates corresponding to a size of 100×100, 50×50 or 10×10. The touch panels may have separate coordinates corresponding to the individual display units. For example, in the mobile terminal 100 having two display units, the touch panels may have coordinates defined using a 100×100 zone and a 100×100 zone assigned respectively to the first display unit 141 and the second display unit 142. To output application data using the multiple display units as a single large screen, touch panel settings may be used in a continuous way. For example, when a touch panel A of the first display unit 141 has coordinates of 0˜100 (x-axis)×0˜100 (y-axis), the control unit 160 may assign coordinates of 101˜200 (x-axis)×0˜100 (y-axis) to a touch panel B of the second display unit 142. As the first display unit 141 and the second display unit 142 are not physically continuous, the control unit 160 may perform a specially designed operation at the border between the touch panels of the first display unit 141 and the second display unit 142. For example, the control unit 160 may assign a longer buffering time to a touch event or long touch event (such as drag or flick) occurring at the border between the first display unit 141 and the second display unit 142 in comparison to a touch event occurring at the other zone. Hence, the control unit 160 may prevent interruption of handling a long touch event occurring at the border between the first display unit 141 and the second display unit 142. The above scheme for handling a long touch event may be applied to the touch panels of the first display unit 141 and the second display unit 142 operating not only in total-view but also in link-view or execution-view (described later).

As described above, in total-view, the mobile terminal 100 may use multiple display units to provide the user with a large screen related to a single application program.

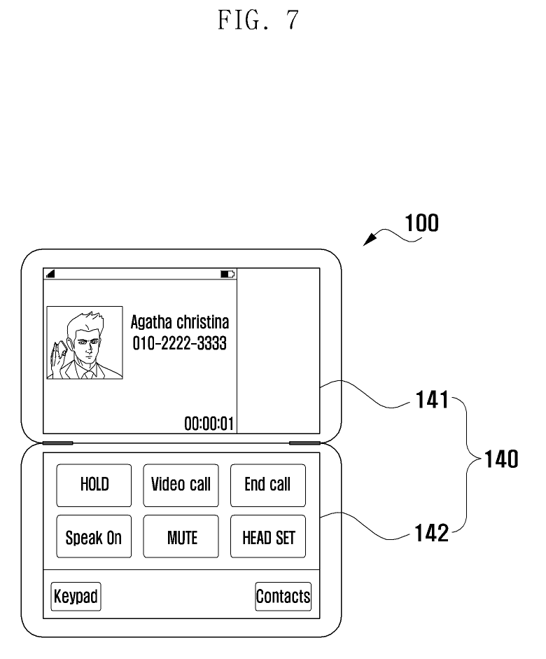

FIG. 7 illustrates output of application data in relation to an execution-view presentation attribute according to an exemplary embodiment of the present invention.

Referring to FIG. 7, the first display unit 141 outputs application data of an activated application program and the second display unit 142 outputs a control key map to control data output on the first display unit 141. The user may generate an input signal to select and activate an application program having a view function and control function. For example, the user may request a video call. The control unit 160 establishes a communication channel for the video call using a phone number provided by the user. After call setup, the control unit 160 may control an operation to output image data received from the called mobile terminal on the first display unit 141 and output a control key map for video call control on the second display unit 142. Although only image data received from the called mobile terminal 100 is displayed on the first display unit 141 in FIG. 7, image data collected by the mobile terminal 100 may also be displayed on the first display unit 141. In this case, the control unit 160 may set up two zones on the first display unit 141 and control an operation to display received image data and collected image data in the separate zones. As shown in FIG. 7, the second display unit 142 displays a control key map, which includes various menu items such as “Hold”, “Video call”, “End call”, “Speak on”, “Mute” and “Headset” for video call control.

During execution-view display, the control unit 160 may assign different touch panel settings to the first display unit 141 and the second display unit 142. For example, the control unit 160 may control an operation to shut off power to the touch panel of the first display unit 141 outputting image data or ignore touch events occurring in the touch panel thereof, and control an operation to set touch-sensitive zones along displayed icons on the touch panel of the second display unit 142.

As another example, when the user activates a camera function, the control unit 160 may control the first display unit 141 to output preview images captured by a camera, and control the second display unit 142 to display a control key map that includes various menu items for camera control such as illumination adjustment, zoom in, zoom out, shutter control, consecutive shooting, and the like. When the user activates a content playback function, the control unit 160 may control the first display unit 141 to output content data, and control the second display unit 142 to display a control key map for content playback control.

To support execution-view display, the control unit 160 examines the presentation attribute of an activated application program and determines whether the presentation attribute indicates execution-view display. When the presentation attribute indicates execution-view display, the control unit 160 may control the first display unit 141 to output application data and control the second display unit 142 to display a control key map for controlling application data output. Alternatively, the control unit 160 may control the second display unit 142 to output application data and control the first display unit 141 to display a control key map for controlling application data output.

As described above, when the mobile terminal 100 executes an application program having an execution-view presentation attribute, it displays different types of data on different display units. Hence, the user may conveniently use the corresponding function without a separate action for control screen display. The display unit to be used to output a given type of data may be determined in advance by the user or be changed by the user after application activation.

The above description of execution-view display is focused on a video call function, content playback function and camera function. However, the present invention is not limited thereto. For example, the mobile terminal 100 may assign an execution-view presentation attribute to various application programs supporting message composition and related key map display for entering alphanumeric keys, and TV broadcast viewing and related control key map display for channel and volume control, and may determine the display unit to be used to output a specific type of data. The execution-view display may be regarded as an association between an application program supporting a data output function and an application program supporting a data output control function.

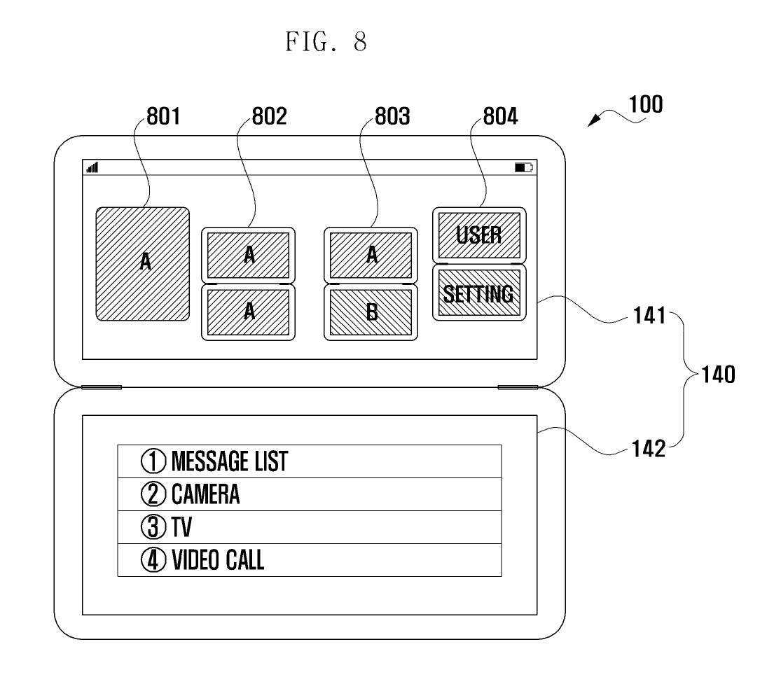

FIG. 8 illustrates a user interface feature for setting a presentation attribute according to an exemplary embodiment of the present invention.

Referring to FIG. 8, in response to selection of a particular menu item, the mobile terminal 100 may output a presentation attribute setting menu including a total-view icon 801, an execution-view icon 802, a link-view icon 803 and a user setting icon 804, as a user interface feature. That is, according to exemplary embodiments of the present invention, a presentation attribute may have a link-view setting, a total-view setting, or an execution-view setting as described before, and may further have a user-defined view setting. Therefore, as illustrated in FIG. 8, a user may be presented with a menu setting screen with which to select a desired presentation attribute.

The mobile terminal 100 may provide such a presentation attribute setting menu in various stages. That is, after an application program having a total-view presentation attribute is activated, when the user generates an input signal for changing the presentation attribute, the presentation attribute setting menu is displayed. Then, the user may change the presentation attribute of the active application program using the presentation attribute setting menu. Data output of the application program may be changed according to the new setting. For example, when the presentation attribute of an application program is changed from total-view to execution-view, the control unit 160 may control one of the display units to output the application data (which was output on all the display units) and control the other display unit to output a control key map for controlling the application program. When the presentation attribute of an application program is changed from total-view to link-view, the control unit 160 may control one of the display units to output the application data (which was output to all display units), activate a related application program having a link-view setting, and control the other display unit to output application data of the related application program. Here, for link-view setting, the control unit 160 controls an operation to output a list of application programs so that the user may directly select an application program to be linked with the current application program from the list.

The presentation attribute setting menu may be provided as a base menu. The user may select the presentation attribute setting menu and set the presentation attribute of a given application program to total-view, execution-view or link-view. Here, when the user selects the presentation attribute setting menu, the control unit 160 may provide a list of selectable application programs.

Using the user setting icon 804, the user may assign a desired presentation attribute to a given application program. For example, the user may assign an alarm function or a deadline function to an application program. Later, the control unit 160 may activate the application program at a given time to output specific application data or an alarm. As described above, the mobile terminal 100 enables the user to assign a user-defined presentation attribute to a selected application program through the user setting icon 804.

When an application program not having a total-view setting is activated, the control unit 160 may regard the application program as having a partial-view setting and output application data on one of the display units of the display means 140. For example, when an application program not having a total-view setting is activated, the control unit 160 may control one of the first display unit 141 and the second display unit 142 to output application data generated by the application program.

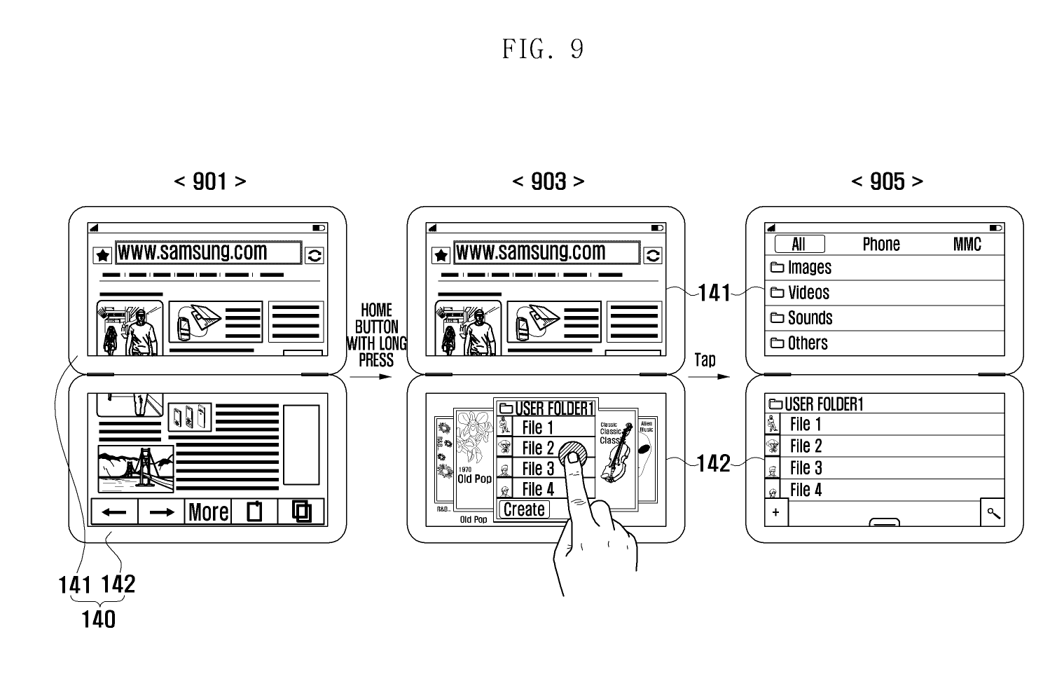

FIG. 9 illustrates changes in application data presentation according to an exemplary embodiment of the present invention.

Referring to FIG. 9, an explanation is provided relating to execution of a web browser. When the user selects a web browser and enters a website address, the mobile terminal 100 establishes a communication channel to a web server indicated by the website address. The mobile terminal 100 receives a webpage from the web server and outputs webpage data on the display means 140 as indicated by reference symbol 901. In this case, the web browser (application program) has a total-view presentation attribute and the webpage data is displayed on the first display unit 141 and the second display unit 142. When the web browser does not have a presentation attribute, the control unit 160 may control one of the first display unit 141 and the second display unit 142 to output the webpage data, and control the other display unit to output data generated by a previously activated application program or a user specified application program.

The user may generate an input signal for activating a user function while webpage data is displayed on a large screen as indicated by reference symbol 901. Thereto, the mobile terminal 100 may include a “home” key on the input unit, and the user may enter the “home” key with a long press. Then, the mobile terminal 100 may activate an application program mapped to the “home” key and output data generated by the application program on the display means 140 as indicated by reference symbol 903. Here, the application program mapped to the “home” key may be an application program activated before activation of the web browser or a user specified application program, and is assumed to be a list search program for finding a desired application program. In this case, as indicated by reference symbol 903, a program search screen having a list of application programs is displayed. The mobile terminal 100 may output the webpage data, which was displayed on the display means 140, on the first display unit 141 and output data generated by the newly activated application program on the second display unit 142. To achieve this, the mobile terminal 100 examines the presentation attribute of the newly activated application program. When the presentation attribute does not include a total-view setting, the mobile terminal 100 may output the webpage data, which was displayed on the display means 140, on one of the first display unit 141 and the second display unit 142 and output data generated by the newly activated application program on the other display unit. When the presentation attribute includes a total-view setting, the mobile terminal 100 may output data generated by the newly activated application program on both the first display unit 141 and the second display unit 142, thereby simulating a large screen.

When the program search screen is displayed, the user may generate a touch event such as drag or flick to find a desired application program through the touch panel on the corresponding display unit. In response to the touch event, the mobile terminal 100 may output a list of various application programs for the user to choose from. The user may select an application program to be executed by touching a zone of the touch panel in which the application program is displayed.

In response to selection of an application program, the mobile terminal 100 may output data generated by the selected application program on the display means 140 as indicated by reference symbol 905. Here, the mobile terminal 100 examines the presentation attribute of the selected application program and outputs application data according to the presentation attribute. For example, when the selected application program has a link-view presentation attribute, the mobile terminal 100 may output data generated by the selected application program on the first display unit 141 (or on the second display unit 142), and output data generated by an application program linked with the selected application program on the second display unit 142 (or on the first display unit 141). For example, when the selected application program supports a content folder listing function and the application program linked therewith supports a sub-folder listing function, the mobile terminal 100 may use the first display unit 141 to output a list of content folders and use the second display unit 142 to output a list of sub-folders belonging to a default folder or a user-specified folder in the content folder list. As described above, it may be assumed that a first application program has a total-view presentation attribute and is activated first, and a second application program has a presentation attribute requiring use of the whole of the display means 140 and is activated next. Then, the mobile terminal 100 may remove data of the first application program having a total-view setting from the display means 140 and output data of the second application program on the display means 140.

In addition, the user may generate a drag event or flick event to move a data item from the second display unit 142 to the first display unit 141. As described before, to properly handle a long touch event, the control unit 160 may assign a longer buffering time to a touch event occurring at the border between the first display unit 141 and the second display unit 142 in comparison to a touch event occurring at the other zone. Hence, the user may generate an input signal to select a data item on the second display unit 142 and move the selected data item to a specific folder of the content folder list on the first display unit 141.

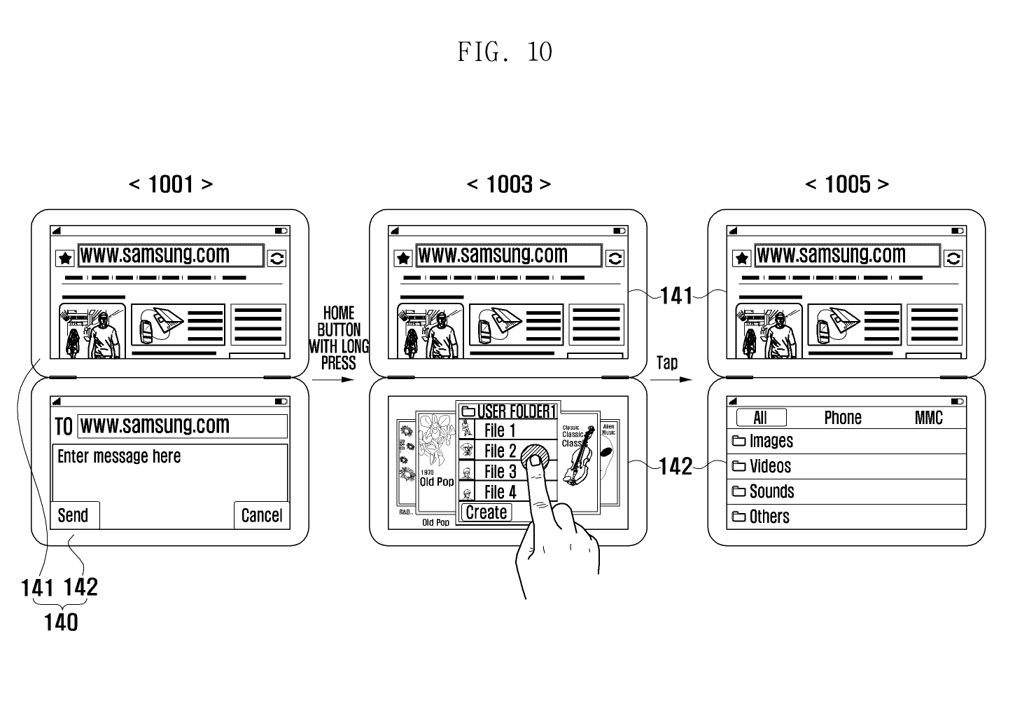

FIG. 10 illustrates changes in application data presentation according to an exemplary embodiment of the present invention.

Referring to FIG. 10, reference symbol 1001 indicates that the first display unit 141 outputs webpage data received from a web server according to activation of a first application program (web browser), and the second display unit 142 outputs a message composition window according to activation of a second application program supporting a message composition function. To this end, the user may select and activate a paired menu item associated with both the web browser and the message composition function, may activate the web browser first and then activate the message composition function, or may activate the message composition function first and then activate the web browser. Thereafter, the user may generate an input signal using the “home” key of the input unit 120 to activate a particular application program. For example, the user may generate an input signal using the “home” key to activate a list search application program for locating a desired application program.

In response to activation of the list search application program, as indicated by reference symbol 1003, the mobile terminal 100 may use the second display unit 142 to output data generated by the list search application program. Here, the mobile terminal 100 examines the presentation attribute of the list search application program and uses one of the display units to output application data according to the presentation attribute. For example, when the presentation attribute indicates output of application data on the second display unit 142, the control unit 160 may control the second display unit 142 to output the application data.

When data generated by the list search application program is output, the user may generate an input signal such as a touch event to locate and select a desired application program using the second display unit 142. In response to the input signal, the mobile terminal 100 may use the second display unit 142 to output data generated by the newly selected application program. Here, although the selected application program has a link-view presentation attribute, the mobile terminal 100 may sustain the existing data on the first display unit 141 in consideration of the presentation attribute of the application program in execution before entering the “home” key. Alternatively, the mobile terminal 100 may use the first display unit 141 to output data generated by the newly selected application program and use the second display unit 142 to output the message composition window indicated by reference symbol 1001.

That is, the mobile terminal 100 may compare priority information of a newly activated application program with that of a currently executed application program, and control data output of the application programs according to the comparison result. Here, priority information may be inserted in the presentation attribute of an application program. The priority information may be changed during execution of the corresponding application program according to the type of data output on the display means 140. For example, the mobile terminal 100 may control a newly selected application program to inherit the presentation attribute of an application program activated before generation of a particular key input signal, and use the display means 140 to output data generated by the newly selected application program according to the inherited presentation attribute.

Although not shown, if necessary, the mobile terminal 100 may further include at least one of a short-range communication module for short-range communication, a camera module for capturing still or moving images of a target object, a data communication interface based on wired and wireless communication, an Internet communication module for Internet access, and a digital broadcast receiving module. With the digital convergence trend, it should be apparent to those skilled in the art that the mobile terminal 100 of the present invention may further include a unit comparable to the above-described units, and one unit of the mobile terminal 100 may be removed or replaced with another unit.

The mobile terminal 100 having multiple display units may provide communication services based on various communication schemes, and may be any information and communication appliance or multimedia appliance, such as a mobile communication terminal supporting various communication protocols, a Portable Multimedia Player (PMP), a digital broadcast receiver, a Personal Digital Assistant (PDA), a music player like an MP3 player, a portable game console, a smart phone, a notebook computer, or a handheld computer.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A data handling method for a mobile terminal having multiple display units, the method comprising:
selecting a particular application program;
examining a presentation attribute of the selected application program; and
performing, according to the presentation attribute, output control to output data generated by activation of the selected application program on at least one of the multiple display units.

2. The method of claim 1, wherein the selecting of the particular application program comprises at least one of:
receiving an input signal for selecting the application program; and
selecting the application program according to preset schedule information.

3. The method of claim 1, wherein the examining of the presentation attribute comprises at least one of:
determining whether the presentation attribute has a total-view setting that requests application data generated by the selected application program to be output on all of the multiple display units simulating a large screen;
determining whether the presentation attribute has a link-view setting that requests activation of a new application program linked with the selected application program, requests application data generated by the selected application program to be output on one of the multiple display units, and requests application data generated by the new application program to be output on another display unit; and
determining whether the presentation attribute has an execution-view setting that requests application data generated by the selected application program to be output on one of the multiple display units and requests a control key map for controlling output of the application data to be output on the other display unit.

4. The method of claim 3, wherein the examining of the presentation attribute further comprises combining, when the presentation attribute has the total-view setting, coordinates of touch panels placed respectively on the display units.

5. The method of claim 4, wherein the examining of the presentation attribute further comprises assigning a longer buffering time to a touch event occurring at the border between the display units in comparison to a touch event occurring at another zone.

6. The method of claim 3, wherein the performing of the output control comprises:
arranging data items generated by associated application programs having the link-view presentation attribute or the execution-view presentation attribute in memory segments corresponding to the individual display units; and
outputting the data items arranged in the memory segments to the corresponding individual display units.

7. The method of claim 6, wherein the performing of the output control further comprises:
determining if the outputting of the data items is to be altered so as to output the data items to different corresponding display units; and
if it is determined that the data items are to be output to the different corresponding display units, changing paths of the memory segments to the corresponding different display units.

8. The method of claim 1, wherein the examining of the presentation attribute comprises:
identifying a presentation attribute of a previous application program having generated existing data on the display units before selection of the particular application program;
controlling the selected application program to inherit the presentation attribute of the previous application program; and
controlling at least one of the display units to output data generated by the selected application program according to the inherited presentation attribute.

9. The method of claim 1, further comprising assigning a presentation attribute to a given application program, wherein the presentation attribute indicates at least one of the multiple display units to be used to output application data generated by the given application program.

10. The method of claim 9, wherein the assigning of the presentation attribute is performed during the output of data generated by the activation of the selected application program on at least one of the multiple display units.

11. The method of claim 9, wherein the assigning of the presentation attribute is performed before the output of data generated by the activation of the selected application program on at least one of the multiple display units.

12. A mobile terminal having multiple display units, the mobile terminal comprising:
a display means having multiple display units;
a storage unit for storing at least one application program that outputs data on at least one of the display units when activated; and
a control unit for examining a presentation attribute of an application program selected according to an input signal or preset schedule information, and for controlling at least one of the display units to output data generated by the selected application program after activation according to the presentation attribute.

13. The mobile terminal of claim 12, wherein the control unit comprises:
an application program examiner for determining a presentation attribute of an application program;
a data arranger for arranging application data generated by the application program after activation in a memory space; and
a data output controller for controlling an operation to output the application data arranged in the memory space to at least one of the display units.

14. The mobile terminal of claim 12, wherein the presentation attribute comprises at least one of:
a total-view setting which requests application data generated by the selected application program to be output on all the multiple display units simulating a large screen;
a link-view setting which requests activation of a new application program linked with the selected application program, requests application data generated by the selected application program to be output on one of the multiple display units, and requests application data generated by the new application program to be output on another display unit; and
an execution-view setting which requests application data generated by the selected application program to be output on one of the multiple display units and requests a control key map for controlling output of the application data to be output on the other display unit.

15. The mobile terminal of claim 14, wherein the data arranger arranges data items generated by associated application programs having the link-view presentation attribute or the execution-view presentation attribute in memory segments corresponding to the individual display units; and
the data output controller outputs the data items arranged in the memory segments to the corresponding individual display units.

16. The mobile terminal of claim 14, further comprising touch panels placed respectively on the display units and whose coordinates are combined when the presentation attribute has a total-view setting.

17. The mobile terminal of claim 14, wherein the control unit assigns a longer buffering time to a touch event occurring at the border between the display units in comparison to a touch event occurring at another zone.

18. The mobile terminal of claim 12, wherein the control unit identifies a presentation attribute of a previous application program having generated the existing data on the display units before selection of the particular application program, and controls the selected application program to inherit the presentation attribute of the previous application program and controls at least one of the display units to output data generated by the selected application program according to the inherited presentation attribute.

19. The mobile terminal of claim 12, wherein the control unit provides, in response to an input signal, a user interface feature enabling the user to assign a presentation attribute to a given application program, and wherein the presentation attribute indicates at least one of the multiple display units to be used to output application data generated by the given application program.
